(19) United States
(12) Patent Application Publication
(10) Pub. No.: US 2018/0357407 A1
(43) Pub. Date: Dec. 13, 2018

(54) AUTHENTICATION SYSTEM WITH MOTION PARAMETERS

(71) Applicant: Carrier Corporation, Palm Beach Gardens, FL (US)

(72) Inventors: Sofiane Yous, Cork (IE); Ankit Tiwari, Burlington, MA (US); Rodolfo De Paz Alberola, Cork (IE); John M. Milton-Benoit, West Suffield, CT (US)

(21) Appl. No.: 15/780,383

(22) PCT Filed: Nov. 29, 2016
(86) PCT No.: PCT/US2016/063922

§ 371 Date: May 31, 2018

Related U.S. Application Data
(60) Provisional application No. 62/262,519, filed on Dec. 3, 2015.

(51) Int. Cl. G06F 21/44; G06F 17/30

(52) U.S. Cl. CPC G06F 21/44; G06F 17/30241; G06F 17/30289

(57) ABSTRACT

A method and apparatus to control access to at least one resource is provided, the method including identifying a location parameter of a mobile device via a locating system, verifying the location parameter with a location parameter database via an authentication processor, receiving a motion parameter of the mobile device via at least one motion sensor of the mobile device, verifying the motion parameter with a motion parameter data-base via the authentication processor, and selectively providing access to the at least one resource in response to the location parameter and the motion parameter via the authentication processor.

### DESCRIPTION OF RELATED ART

The subject matter disclosed herein relates to controlling access to resources, and to a system and a method for controlling access to resources utilizing motion parameters.

Typically, authentication systems for controlling access to resources require significant user interaction to authenticate the user and signal user intention. For example, a user requesting access to a certain resource may need to identify the resource to be accessed and then enter additional credentials.

Authentication systems are often used in buildings that have numerous users and numerous accessible resources. Current authentication systems may require significant user interaction to allow access or may otherwise compromise access integrity to minimize user interaction. A system and method that can provide access control for resources with minimal user interaction while maintaining access integrity is desired.

### BRIEF SUMMARY

According to an embodiment, a method to control access to at least one resource is provided, the method including identifying a location parameter of a mobile device via a locating system, verifying the location parameter with a location parameter database via an authentication processor, receiving a motion parameter of the mobile device via at least one motion sensor of the mobile device, verifying the motion parameter with a motion parameter database via the authentication processor, and selectively providing access to the at least one resource in response to the location parameter and the motion parameter via the authentication processor.

In addition to one or more of the features described above, or as an alternative, further embodiments could include providing a credential parameter via the mobile device, verifying the credential parameter with a credential parameter database via the authentication processor, and selectively providing access to the at least one resource in response to the location parameter, the motion parameter, and the credential parameter via the authentication processor.

In addition to one or more of the features described above, or as an alternative, further embodiments could include receiving the credential parameter via an interface of the mobile device.

In addition to one or more of the features described above, or as an alternative, further embodiments could include that the at least one resource includes a plurality of resources.

In addition to one or more of the features described above, or as an alternative, further embodiments could include identifying a desired resource of the plurality of resources in response to the location parameter via the authentication processor, and selectively providing access to the desired resource in response to the location parameter and the motion parameter via the authentication processor.

In addition to one or more of the features described above, or as an alternative, further embodiments could include identifying a desired resource of the plurality of resources in response to the motion parameter via the authentication processor, and selectively providing access to the desired resource in response to the location parameter and the motion parameter via the authentication processor.

In addition to one or more of the features described above, or as an alternative, further embodiments could include that the motion sensor includes at least one of a gyroscope, a compass, a global positioning system, a screen input, and an accelerometer. In addition to one or more of the features described above, or as an alternative, further embodiments could include that the locating system is a real time locating system.

According to an embodiment, an authentication system to control access to at least one resource is provided, the system including a mobile device including at least one motion sensor and a locating device, wherein the motion sensor receives a motion parameter, a locating system in communication with the locating device of the mobile device to determine a location parameter of the mobile device, and an authentication processor to verify the location parameter with a location parameter database, to verify the motion parameter with a motion parameter database, and to selectively provide access to the at least one resource in response to the location parameter and the motion parameter.

In addition to one or more of the features described above, or as an alternative, further embodiments could include that the mobile device provides a credential parameter and the authentication processor verifies the credential parameter with a credential parameter database and selectively provides access to the at least one resource in response to the location parameter, the motion parameter, and the credential parameter.

In addition to one or more of the features described above, or as an alternative, further embodiments could include that the mobile device includes an interface to receive the credential parameter.

In addition to one or more of the features described above, or as an alternative, further embodiments could include that the at least one resource includes a plurality of resources.

In addition to one or more of the features described above, or as an alternative, further embodiments could include that the authentication processor identifies a desired resource of the plurality of resources in response to the location parameter and selectively provides access to the desired resource in response to the location parameter and the motion parameter.

In addition to one or more of the features described above, or as an alternative, further embodiments could include that the authentication processor identifies a desired resource of the plurality of resources in response to the motion parameter and selectively provides access to the desired resource in response to the location parameter and the motion parameter.

In addition to one or more of the features described above, or as an alternative, further embodiments could include that, wherein the at least one resource includes the authentication processor.

Technical function of the embodiments described above includes receiving a motion parameter of the mobile device via at least one motion sensor of the mobile device, verifying the motion parameter with a motion parameter database via the authentication processor, and selectively providing access to the at least one resource in response to the motion parameter via the authentication processor.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of an authentication system; and

FIG. 2 is a flow diagram of a method of controlling access to at least one resource.

### DETAILED DESCRIPTION

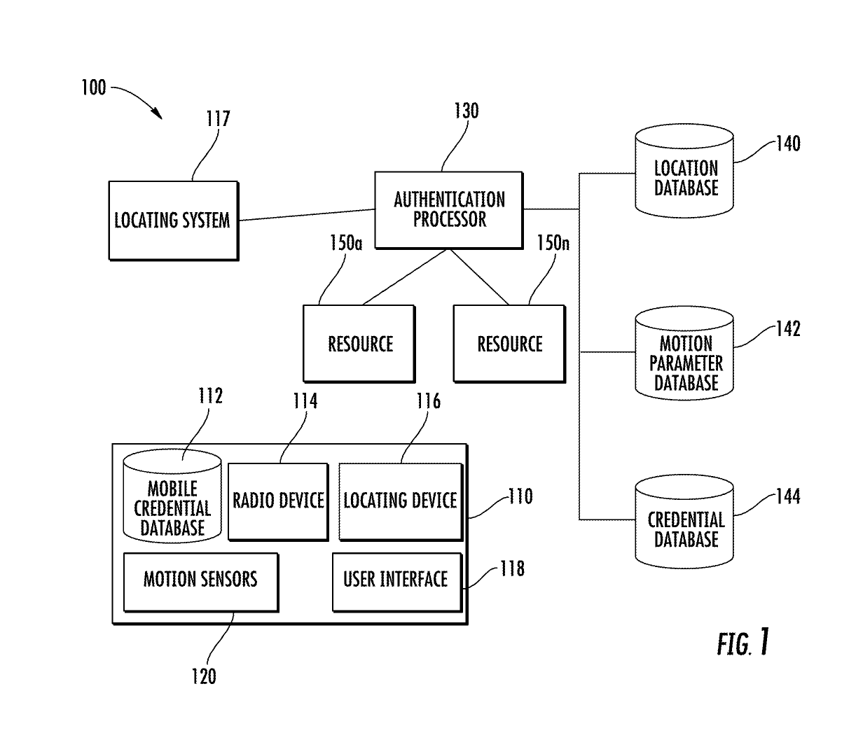

Referring now to the drawings, FIG. 1 illustrates a schematic view of an authentication system 100 suitable for use with a building or any other suitable location to control access to resources. In the illustrated embodiment, the authentication system 100 includes a mobile device 110, a locating system 117, an authentication processor 130, and resources 150-150n. In the illustrated embodiment, the authentication processor 130 can utilize motion parameters provided by the mobile device 110 to selectively grant or deny access to a resource 150a-150n. In certain embodiments, the authentication processor 130 can further utilize motion parameters provided by the mobile device 110 to identify which resource 150a-150n the user intends to access. Advantageously, the authentication system 100 can provide controlled access to resources 150a-150n with minimal user collaboration or interaction while maintaining access control integrity.

In the illustrated embodiment, the mobile device 110 includes a mobile credential database 112, a radio device 114, a locating device 116, a user interface 118, and motion sensors 120. In the illustrated embodiment, the mobile device 110 can work in conjunction with the locating system 117 and the authentication processor 130 to identify a user, authenticate the user, and signal which resource the user intends to access. In the illustrated embodiment, motion provided by the user can be received by the mobile device 110 to provide access to resources 150a-150n. In the illustrated embodiment, the mobile device 110 can a mobile phone, a tablet, a dedicated device, or any other suitable device that is associated with the user.

In the illustrated embodiment, the mobile device 110 can provide credentials associated with the user to the authentication processor 130. In certain embodiments, the user can enter user credentials as prompted by the authentication system 100. In the illustrated embodiment, the user interface 118 can allow a user to input information to the authentication system 100. In the illustrated embodiment, the user interface 118 can be a touch screen, a keyboard, a button, etc. to receive user input. In the illustrated embodiment, the user interface 118 can receive a user's credentials, such as their personal identification number (PIN), password, username, etc. In certain embodiments, the user interface 118 can receive taps, swipes, and other gestures which can be used as an authentication credential or a motion parameter by the authentication processor 130.

In certain embodiments, the mobile credential database 112 can store credentials such as user names, passwords, PINs, etc. In certain embodiments, the mobile credential database 112 can provide credentials to the authentication processor 130 as needed instead of prompting the user to enter credentials via the user interface 118. In certain embodiments, the credentials can be stored in the mobile credential database 112 for a limited amount of time. In other embodiments, the credentials are stored indefinitely in the mobile credential database 112.

In the illustrated embodiment, the radio device 114 can be utilized to transmit information such as credentials, motion parameters, etc., to the authentication processor 130. In certain embodiments, the radio device 114 can further receive information from the authentication processor 130. In the illustrated embodiment, the radio device 114 can be any suitable radio device, including, but not limited to cellular radio, Wi-Fi radio, Bluetooth, near field communication, etc.

In the illustrated embodiment, the mobile device 110 can provide a representative location of the user via either the locating device 116 or the radio device 114. In the illustrated embodiment, the locating device 116 can provide a location to the authentication processor via the locating system 117. In the illustrated embodiment, the locating device 116 can utilize a beacon, GPS receiver, etc. to determine a location of the mobile device 110 associated with a user. In certain embodiments, the locating device 116 can provide a signal to the locating system 117 to provide a mobile device 110 location. In certain embodiments, the radio device 114 can be used in conjunction with the locating system 117 to provide a location of the mobile device 110. In certain embodiments, the radio device 114 can provide signal that can be analyzed by the locating system 117 to determine a signal strength or a signal proximity of the mobile device 110.

In the illustrated embodiment, motion sensors 120 can receive and characterize motion of a user. In certain embodiments, the motion sensors 120 can create a motion profile of a user during specific intentional actions, such as waving, shaking, and other intentional gestures and patterns. In other embodiments, the motion sensors 120 can create a motion profile of unintentional motion such as a user's gait or other unintentional motion and patterns. Advantageously, motion inputs from the user can require minimal user interaction while still providing parameter that is verifiable via the authentication processor 130. In the illustrated embodiment, motion sensors 120 can include, but are not limited to gyroscopes, accelerometers, compasses, position sensors, etc. In the illustrated embodiment, motion sensors 120 can utilize machine learning and other analysis to characterize the motion received by the motion sensors 120.

In the illustrated embodiment, the locating system 117 can provide location parameters of the mobile device 110. In certain embodiments, the locating device 117 can work in conjunction with the radio device 114 or the locating device 116 to determine the proximity of the mobile device 110 via time of flight calculations, triangulation, etc. In certain embodiments, the locating device 117 can work in conjunction with a locating device 116 which may act as a beacon, a dedicated location device or otherwise provide location information to the locating device 117. In the illustrated embodiment, the locating system 117 is a real time locating system (RTLS) to locate the mobile device 110. In certain embodiments, the locating device 117 can be embedded in or include a wireless access point, Wi-Fi router, etc. In certain embodiments, the locating system 117 can determine if the mobile device 110 is near a certain specific resource 150a-150n.

In the illustrated embodiment, the authentication system 100 can control access to the resources 150a-150n. In the illustrated embodiment, resources 150a-150n can include doors, gates, computer access, elevators, or any other resource that may require access control.

In the illustrated embodiment, the authentication processor 130 can control access to the resources 150a-150n. In the illustrated embodiment, the authentication processor 130 is operatively connected to the locating system 117, resources 150a-150n, a location database 140, a motion parameter database 142, and a credential database 144. In the illustrated embodiment, the authentication processor 130 can compare and verify parameters received from the mobile device 110 and the locating system 117 against known and authorized parameters within the location database 140, the motion parameter database 142, and the credential database 144 to grant or deny a user access to a selected resource 150a-150n. In certain embodiments, the authentication processor 130 can be embedded within resources 150a-150n to allow a mobile device 110 to directly communicate with the resources 150a-150n. In certain embodiments, the resources 150a-150n can further include the location database 140, the motion parameter database 142, and the credential database 144.

In the illustrated embodiment, the authentication processor 130 can identify the location of the mobile device 110 and compare the location parameter to the location database 140. In the illustrated embodiment, the location database 140 contains records regarding authorized locations wherein the user may be located to access a given resource 150a-150n. In certain embodiments, the authentication processor 130 can compare the location database 140 records with the location parameter to ensure the user in the correct location to request access to the resource 150a-150n. In other embodiments, the authentication processor 130 can further utilize the location parameter of the mobile device 110 to determine which resource 150a-150n the user intends to access. For example, the authentication processor 130 may determine the proximity of the mobile device 110 to a given resource 150a-150n. Therefore, the authentication processor 130 can identify the resource 150a-150n or the group of resources 150a-150n the user intends to access.

In the illustrated embodiment, the authentication processor 130 can characterize the motion profile received by the mobile device 110 and compare the motion parameters to motion parameters stored in the motion parameter database 142. In the illustrated embodiment, the motion parameter database 142 includes authenticated motion parameters records that permit the user to access a given resource 150a-150n. In certain embodiments, the motion parameters can be analyzed with pattern matching methods and machine learning to characterize the motions of the user both to store motion parameter records within the motion parameter database 142 and for the authentication processor 130 to verify the received motion profile. In certain embodiments, algorithms can be utilized to characterize intentional movements such as gestures. In other embodiments algorithms can be utilized to characterize unintentional movements such as natural movement, gait of a user, etc.

In the illustrated embodiment, the motion parameters can be compared with the motion parameter database 142 to provide an additional factor of authentication in addition to or in lieu of the credentials and location, etc. In other embodiments, the authentication processor 130 can further utilize the motion parameter of the mobile device 110 to determine which resource 150a-150n the user intends to access. For example, a user can perform a gesture to access a first resource 150a and then perform another gesture to access another resource 150n. Therefore, the authentication processor 130 can identify the resource 150a-150n or the group of resources 150a-150n the user intends to access. In certain embodiments, the authentication processor 130 can analyze motion parameters in conjunction with the location parameters of the mobile device 110.

In the illustrated embodiment, the authentication processor 130 can receive credentials from the mobile device 110 and compare the credentials to the credential database 144. In the illustrated embodiment, the credential database 144 contains records regarding authorized credentials to access a given resource 150a-150n. In certain embodiments, the authentication processor 130 can compare the provided credentials with the records of the credential database 144 to ensure the user is authorized to receive access to a given resource 150a-150n. In the illustrated embodiment, the credentials can be verified after the motion parameters are previously authenticated.

In certain embodiments, the location of the mobile device 110, the motion parameters of the mobile device 110, and the credentials provided by the mobile device can be utilized by the authentication processor 130 to select an intended resource 150a-150n. In the illustrated embodiment, the authentication processor 130 can verify parameters such as the location of the mobile device 110, the motion parameters of the mobile device 110, and the credentials provided by the mobile device 110 to provide a grant or deny determination for the intended resource 150a-150n. In certain embodiments, the authentication processor 130 is directly connected to the resources 150a-150n. In other embodiments, the authentication processor 130 can utilize indirect control such as cloud control or control via a security platform to control the resources 150a-150n. In certain embodiments, the authentication processor 130 can utilize access control software to communicate with intermediate devices such as access control panels to control access to resources 150a-150. In certain embodiments, the authentication processor 130 can utilize intermediate interfaces to access and communicate via legacy access control mechanisms, including, but not limited to RS485 serial communications. Advantageously, the authentication system 100 allows for selective access to resources 150a-150n with minimal user interaction while maintaining access control integrity.

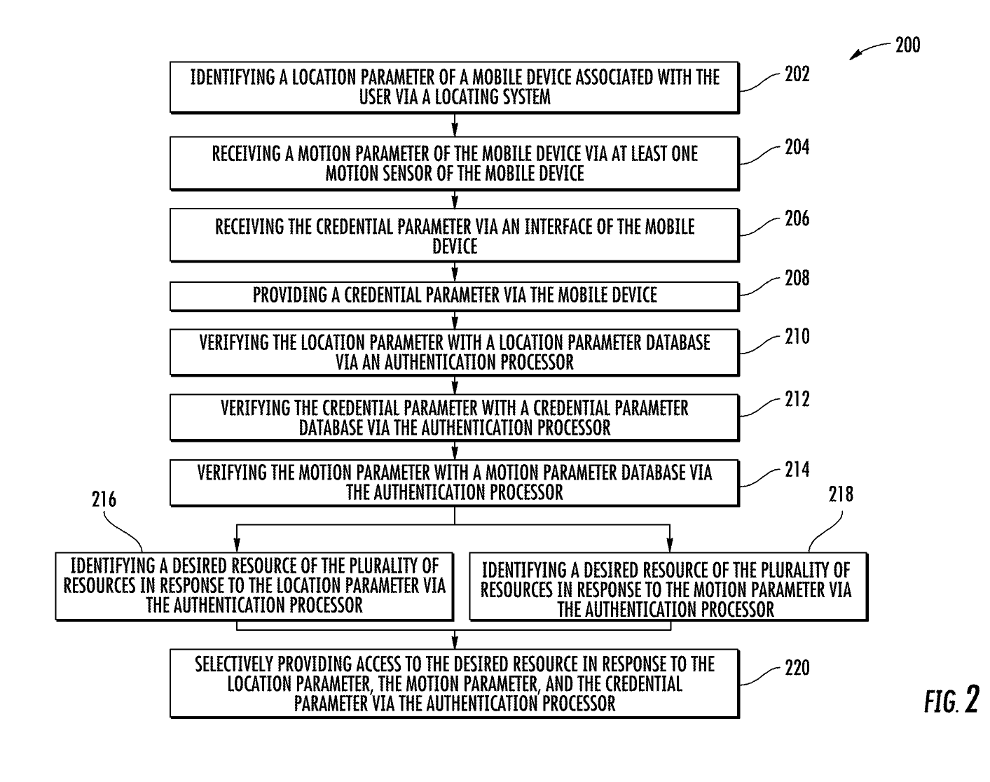

Referring to FIG. 2, a method 200 for controlling access to at least one resource is shown. In operation 202, a location parameter of a mobile device associated with the user is identified via a locating system. In certain embodiments, the locating device can work in conjunction with the radio device or the locating device to determine a location of the mobile device via time of flight calculations, triangulation, etc.

In operation 204, a motion parameter of the mobile device is received via at least one motion sensor of the mobile device. In certain embodiments, the motion sensors can create a motion profile of a user during specific intentional actions, such as waving, shaking, and other intentional gestures and patterns. In other embodiments, the motion sensors can create a motion profile of unintentional motion such as a user's gait or other unintentional motion and patterns.

In operation 206, the credential parameter is received via an interface of the mobile device. In certain embodiments, the user can enter user credentials as prompted by the authentication system. In the illustrated embodiment, the user interface can allow a user to input information to the authentication system, such as passwords, PINs, etc.

In operation 208, a credential parameter is provided via the mobile device. In the illustrated embodiment, the radio device can be utilized to transmit information such as entered or stored credentials, etc., to the authentication processor.

In operation 210, the location parameter is verified with a location parameter database via an authentication processor. In the illustrated embodiment, the authentication processor 10 can identify the location of the mobile device and compare the location parameter to the location database. In the illustrated embodiment, the location database contains records regarding authorized locations wherein the user may be located to access a given resource. In certain embodiments, the authentication processor can compare the location database records with the location parameter to ensure the user in the correct location to request access to the resource.

In operation 212, the credential parameter is verified with a credential parameter database via the authentication processor. In the illustrated embodiment, the authentication processor can receive credentials from the mobile device and compare the credentials to the credential database. In the illustrated embodiment, the credential database contains records regarding authorized credentials to access a given resource.

In operation 214, the motion parameter is verified with a motion parameter database via the authentication processor. In the illustrated embodiment, the authentication processor can characterize the motion profile received by the mobile device and compare the motion parameters to motion parameters stored in the motion parameter database. In the illustrated embodiment, the motion parameter database includes authenticated motion parameters records that permit the user to access a given resource. In the illustrated embodiment, the motion parameters can be compared with the motion parameter database to provide an additional factor of authentication in addition to or in lieu of the credentials and location, etc.

In operation 216, a desired resource of the plurality of resources is identified in response to the location parameter via the authentication processor. In certain embodiments, the authentication processor can further utilize the location parameter of the mobile device to determine which resource the user intends to access. For example, the authentication processor may determine the proximity of the mobile device to a given resource to identify the intended resource.

In operation 218, a desired resource of the plurality of resources is identified in response to the motion parameter via the authentication processor. In certain embodiments, the authentication processor can further utilize the motion parameter of the mobile device to determine which resource the user intends to access. For example, a user can perform a gesture to access a first resource and then perform another gesture to access another resource.

In operation 220, access to the desired resource is selectively provided in response to the location parameter, the motion parameter, and the credential parameter via the authentication processor. In the illustrated embodiment, the authentication processor can verify parameters such as the location of the mobile device, the motion parameters of the mobile device, and the credentials provided by the mobile device to provide a grant or deny determination for the intended resource.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

1. A method to control access to at least one resource, the method comprising:
identifying a location parameter of a mobile device via a locating system;
verifying the location parameter with a location parameter database via an authentication processor;
receiving a motion parameter of the mobile device via at least one motion sensor of the mobile device;
verifying the motion parameter with a motion parameter database via the authentication processor; and
selectively providing access to the at least one resource in response to the location parameter and the motion parameter via the authentication processor.

2. The method of claim 1, further comprising:
providing a credential parameter via the mobile device;
verifying the credential parameter with a credential parameter database via the authentication processor; and
selectively providing access to the at least one resource in response to the location parameter, the motion parameter, and the credential parameter via the authentication processor.

3. The method of claim 2, further comprising:
receiving the credential parameter via an interface of the mobile device.

4. The method of claim 1, wherein the at least one resource includes a plurality of resources.

5. The method of claim 4, further comprising:
identifying a desired resource of the plurality of resources in response to the location parameter via the authentication processor; and
selectively providing access to the desired resource in response to the location parameter and the motion parameter via the authentication processor.

6. The method of claim 4, further comprising:
identifying a desired resource of the plurality of resources in response to the motion parameter via the authentication processor; and
selectively providing access to the desired resource in response to the location parameter and the motion parameter via the authentication processor.

7. The method of claim 1, wherein the motion sensor includes at least one of a gyroscope, a compass, a global positioning system, a screen input, and an accelerometer.

8. The method of claim 1, wherein the locating system is a real time locating system.

9. An authentication system to control access to at least one resource, the authentication system comprising:
a mobile device including at least one motion sensor and a locating device, wherein the motion sensor receives a motion parameter;
a locating system in communication with the locating device of the mobile device to determine a location parameter of the mobile device; and
an authentication processor to verify the location parameter with a location parameter database, to verify the motion parameter with a motion parameter database, and to selectively provide access to the at least one resource in response to the location parameter and the motion parameter.

10. The authentication system of claim 9, wherein the mobile device provides a credential parameter and the authentication processor verifies the credential parameter with a credential parameter database and selectively provides access to the at least one resource in response to the location parameter, the motion parameter, and the credential parameter.

11. The authentication system of claim 10, wherein the mobile device includes an interface to receive the credential parameter.

12. The authentication system of claim 9, wherein the at least one resource includes a plurality of resources.

13. The authentication system of claim 12, wherein the authentication processor identifies a desired resource of the plurality of resources in response to the location parameter and selectively provides access to the desired resource in response to the location parameter and the motion parameter.

14. The authentication system of claim 12, wherein the authentication processor identifies a desired resource of the plurality of resources in response to the motion parameter and selectively provides access to the desired resource in response to the location parameter and the motion parameter.

15. The authentication system of claim 9, wherein the at least one resource includes the authentication processor.
